(19) United States
(12) Patent Application Publication
(10) Pub. No.: US 2017/0059757 A1
(43) Pub. Date: Mar. 2, 2017

(54) OPTICAL LAMINATE

(71) Applicant: NITTO DENKO CORPORATION, Osaka (JP)

(72) Inventors: Tadashi Kojima, Ibaraki-shi (JP); Kentarou Takeda, Ibaraki-shi (JP); Nao Murakami, Ibaraki-shi (JP)

(73) Assignee: NITTO DENKO CORPORATION, Osaka (JP)

(21) Appl. No.: 15/246,826

(22) Filed: Aug. 25, 2016

(30) Foreign Application Priority Data
Sep. 1, 2015 (JP) 2015-172035
Jun. 20, 2016 (JP) 2016-121701

(51) Int. Cl. G02B 5/30; G02B 1/111

(52) U.S. Cl. CPC G02B 5/305; G02B 1/111; G02B 5/3083

(57) ABSTRACT

Provided is an optical laminate in which color unevenness resulting from an antireflection film is prevented, the optical laminate being thin and excellent in neutral black reflection hue. The optical laminate includes: a first substrate; a second substrate arranged on one side of the first substrate; an antireflection film arranged between the first substrate and the second substrate; and a resin layer arranged between the first substrate and the second substrate to cover the antireflection film, in which: the antireflection film includes a polarizer and a retardation layer bonded to the polarizer; and the resin layer has a storage modulus of elasticity at 25° C. of 1×10⁶ Pa or more.

This application claims priority under 35 U.S.C. Section 119 to Japanese Patent Application No. 2015-172035 filed on Sep. 1, 2015 and No. 2016-121701 filed on Jun. 20, 2016, which are herein incorporated by references.

### BACKGROUND OF THE INVENTION

1. Field of the Invention

The present invention relates to an optical laminate.

2. Description of the Related Art

Various optical films have heretofore been used in image display apparatus typified by a liquid crystal display apparatus and an organic EL display apparatus to achieve improvements in viewing angle characteristics and reflection characteristics thereof. In, for example, an organic EL display apparatus having a highly reflective metal layer, a problem, such as the reflection of ambient light or the reflection of a background, is liable to occur. Accordingly, a circularly polarizing plate having a λ/4 plate is sometimes used as an antireflection film.

Meanwhile, in each of the image display apparatus, the occurrence of the color unevenness of an end portion due to its long-term use becomes a problem. The use of an optical film having a small photoelastic coefficient has been known as a method of preventing color unevenness resulting from an optical film, and a cycloolefin-based film is frequently used as the optical film having a small photoelastic coefficient. The cycloolefin-based film can also be used as a λ/4 plate. However, owing to wavelength dispersibility inherent in a material therefor, the cycloolefin-based film involves a problem in that a neutral black reflection hue is not obtained with the film alone. When an attempt is made to obtain the neutral black reflection hue while using the cycloolefin-based film, an optical film that functions as a λ/2 plate needs to be further used, and hence the following problems occur. The productivity of the image display apparatus reduces and its thickness increases.

### SUMMARY OF THE INVENTION

The present invention has been made to solve the conventional problems, and a primary object of the present invention is to provide an optical laminate in which color unevenness resulting from an antireflection film is prevented, the optical laminate being thin and excellent in neutral black reflection hue.

An optical laminate according to one embodiment of the present invention includes: a first substrate; a second substrate arranged on one side of the first substrate; an antireflection film arranged between the first substrate and the second substrate; and a resin layer arranged between the first substrate and the second substrate to cover the antireflection film, in which: the antireflection film includes a polarizer and a retardation layer bonded to the polarizer; and the resin layer has a storage modulus of elasticity at 25° C. of 1×10⁶ Pa or more.

In one embodiment, the retardation layer functions as a λ/4 plate.

In one embodiment, the retardation layer shows a reverse wavelength dispersion characteristic.

In one embodiment, the retardation layer includes a polycarbonate-based resin film.

In one embodiment, the retardation layer contains a resin having a photoelastic coefficient of 30×10⁻¹² Pa or less.

In one embodiment, an angle formed between a slow axis of the retardation layer and an absorption axis of the polarizer is from 35° to 55°.

In one embodiment, the polarizer and the retardation layer are laminated through intermediation of an adhesive layer, and the adhesive layer has a thickness of 1 μm or less.

According to the present invention, the optical laminate includes the antireflection film including the polarizer and the retardation layer bonded to the polarizer, and is constituted by covering the antireflection film with the resin layer having a specific storage modulus of elasticity. Thus, the thin optical laminate in which color unevenness is prevented can be obtained. In addition, according to the present invention, a material for the retardation layer constituting the antireflection film can be selected from a wide variety of materials (for example, a material having a relatively large photoelastic coefficient or a material that can form a retardation layer having a reverse wavelength dispersion characteristic can be used). Accordingly, the optical laminate that is excellent in neutral black reflection hue while its retardation layer is formed with a single layer can be obtained.

### BRIEF DESCRIPTION OF THE DRAWINGS

FIG. 1 is a schematic sectional view of an optical laminate according to one embodiment of the present invention.

### DETAILED DESCRIPTION OF THE PREFERRED EMBODIMENTS

Now, embodiments of the present invention are described. However, the present invention is not limited to these embodiments.

(Definitions of Terms and Symbols)

The definitions of terms and symbols used herein are as described below.

### (1) Refractive Indices (nx, ny, and nz)

“nx” represents a refractive index in a direction in which an in-plane refractive index is maximum (that is, slow axis direction), “ny” represents a refractive index in a direction perpendicular to the slow axis in the plane (that is, fast axis direction), and “nz” represents a refractive index in a thickness direction.

### (2) In-Plane Retardation (Re)

“Re(λ)” refers to an in-plane retardation measured at 23° C. with light having a wavelength of λnm. For example, “Re (550)” refers to an in-plane retardation measured at 23° C. with light having a wavelength of 550 nm. The Re(λ) is determined from the equation “Re(λ)=(nx−ny)×d” when the thickness of a layer (film) is represented by d (nm).

### (3) Thickness Direction Retardation (Rth)

“Rth(λ)” refers to a thickness direction retardation measured at 23° C. with light having a wavelength of λ nm. For example, “Rth(550)” refers to a thickness direction retardation measured at 23° C. with light having a wavelength of 550 nm. The Rth(λ) is determined from the equation “Rth(λ)=(nx-nz)×d” when the thickness of a layer (film) is represented by d (nm).

### (4) Nz Coefficient

An Nz coefficient is determined from the equation “Nz=Rth/Re”.

(5) Birefringent Index (Δn_{xy})

A birefringent index Δn_{xy} is determined from the equation “Δn_{xy}=nx−ny”.

A. Entire Construction of Optical Laminate

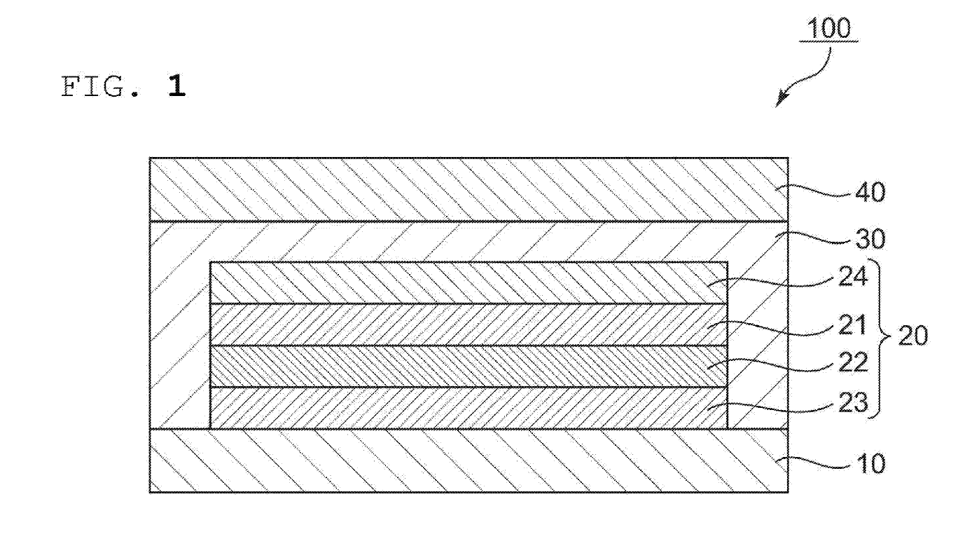

FIG. 1 is a schematic sectional view of an optical laminate according to one embodiment of the present invention. An optical laminate 100 of this embodiment includes: a first substrate 10; a second substrate 40 arranged on one side of the first substrate 10; an antireflection film 20 arranged between the first substrate 10 and the second substrate 40; and a resin layer 30 formed between the first substrate 10 and the second substrate 40 so as to cover and seal the antireflection film 20. The antireflection film 20 includes a polarizer 21 and a retardation layer 22. The retardation layer 22 is bonded to the polarizer 21.

The inventors of the present invention have found that in a conventional antireflection film, i.e., an antireflection film constituted merely by bonding a retardation layer and a polarizer to each other with a pressure-sensitive adhesive layer, the retardation of the retardation layer (especially the retardation of an end portion) changes with time owing to the shrinkage of the retardation layer due to a temperature change, and the change in retardation is responsible for color unevenness. In the present invention, the retardation layer and the polarizer are laminated by bonding, and the antireflection film including the retardation layer is covered with the resin layer. Thus, an optical laminate in which color unevenness is prevented can be obtained. In more detail, in the optical laminate having such a construction as described above, the deformation of the retardation layer is suppressed, and the expansion and shrinkage of the retardation layer due to a temperature change are small. In such optical laminate, a change in retardation of the retardation layer is small, and color unevenness that occurs with time is prevented. In addition, as described later, setting a storage modulus of elasticity E′ of the resin layer within a specific range makes such effects more significant.

It is preferred that the retardation layer and the polarizer be directly bonded to each other. That is, it is preferred that a layer except an adhesive layer (e.g., a film, such as a protective film, or a pressure-sensitive adhesive layer) be not present between the retardation layer and the polarizer. In the optical laminate of the present invention, the retardation layer can also function as a protective layer for the polarizer. When the retardation layer that can also function as the protective layer for the polarizer as described above is directly bonded to the polarizer, a thin optical laminate can be obtained.

The antireflection film can be laminated on the first substrate through intermediation of a pressure-sensitive adhesive layer 23. In addition, the antireflection film 20 can include a protective film 24 arranged on the side of the polarizer 21 opposite to the retardation layer 22. The antireflection film 20 is preferably arranged so that the polarizer 21 (and the protective film 24) may be on the second substrate 40 side with reference to the retardation layer 22. In addition, when the optical laminate 100 of the present invention is used in an image display apparatus or the like, the antireflection film 20 is preferably arranged so that the polarizer 21 (and the protective film 24) may be on a viewer side with reference to the retardation layer 22. For example, when a retardation layer that functions as a λ/4 plate is formed, the polarizer can be arranged to be closer to the viewer side than the retardation layer (λ/4 plate) is. In addition, the optical laminate 100 of the present invention can be arranged while the second substrate 40 is arranged on the viewer side.

B. Antireflection Film

As described above, the antireflection film includes the polarizer and the retardation layer. The retardation layer is arranged on one side of the polarizer and can function as a protective layer for the polarizer. In one embodiment, the retardation layer is a single layer. Practically, a protective film can be arranged on the side of the polarizer opposite to the retardation layer.

(Polarizer)

Any appropriate polarizer may be adopted as the polarizer. For example, a resin film for forming the polarizer may be a single-layer resin film, or may be a laminate of two or more layers.

Specific examples of the polarizer including a single-layer resin film include: a polarizer obtained by subjecting a hydrophilic polymer film, such as a polyvinyl alcohol (PVA)-based resin film, a partially formalized PVA-based resin film, or an ethylene-vinyl acetate copolymer-based partially saponified film, to a dyeing treatment with a dichromatic substance, such as iodine or a dichromatic dye, and a stretching treatment; and a polyene-based alignment film, such as a dehydration-treated product of PVA or a dehydrochlorination-treated product of polyvinyl chloride. A polarizer obtained by dyeing the PVA-based resin film with iodine and uniaxially stretching the resultant is preferably used because the polarizer is excellent in optical characteristics.

The dyeing with iodine is performed by, for example, immersing the PVA-based resin film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching has been performed. The PVA-based resin film is subjected to a swelling treatment, a cross-linking treatment, a washing treatment, a drying treatment, or the like as required. For example, when the PVA-based resin film is immersed in water to be washed with water before the dyeing, contamination or an antiblocking agent on the surface of the PVA-based resin film can be washed off. In addition, the PVA-based resin film is swollen and hence dyeing unevenness or the like can be prevented.

The polarizer obtained by using the laminate is specifically, for example, a polarizer obtained by using a laminate of a resin base material and a PVA-based resin layer (PVA-based resin film) laminated on the resin base material, or a laminate of a resin base material and a PVA-based resin layer formed on the resin base material through application. The polarizer obtained by using the laminate of the resin base material and the PVA-based resin layer formed on the resin base material through application may be produced by, for example, a method involving: applying a PVA-based resin solution onto the resin base material; drying the solution to form the PVA-based resin layer on the resin base material, thereby providing the laminate of the resin base material and the PVA-based resin layer; and stretching and dyeing the laminate to turn the PVA-based resin layer into the polarizer. In this embodiment, the stretching typically includes the stretching of the laminate under a state in which the laminate is immersed in an aqueous solution of boric acid. The stretching may further include the aerial stretching of the laminate at high temperature (e.g., 95° C. or more) before the stretching in the aqueous solution of boric acid as required. The resultant laminate of the resin base material and the polarizer may be used as it is (i.e., the resin base material may be used as a protective film for the polarizer). Alternatively, a product obtained as described below may be used: the resin base material is peeled from the laminate of the resin base material and the polarizer, and any appropriate protective film in accordance with purposes is laminated on the peeling surface. Details of such method of producing a polarizer are disclosed in, for example, Japanese Patent Application Laid-open No. 2012-73580. The entire disclosure of the laid-open publication is incorporated herein by reference.

The thickness of the polarizer is preferably 15 μm or less, more preferably 13 μm or less, still more preferably 10 μm or less, particularly preferably 8 μm or less. A lower limit for the thickness of the polarizer is 2 μm in one embodiment, and is 3 μm in another embodiment.

The polarizer preferably shows absorption dichroism at any wavelength in the wavelength range of from 380 nm to 780 nm. The single axis transmittance of the polarizer is preferably from 44.0% to 45.5%, more preferably from 44.5% to 45.0%.

The polarization degree of the polarizer is preferably 98% or more, more preferably 98.5% or more, still more preferably 99% or more.

(Retardation Layer)

The retardation layer may include a retardation film having any appropriate optical characteristics and/or mechanical characteristics depending on purposes. The retardation layer typically has a slow axis. In one embodiment, an angle θ formed between the slow axis of the retardation layer and the absorption axis of the polarizer is preferably from 35° to 55°, more preferably from 38° to 52°, still more preferably from 42° to 48°, particularly preferably about 45°. When the angle θ falls within such range, through the use of the retardation layer as a λ/4 plate as described later, an antireflection film having an extremely excellent circular polarization characteristic (consequently an extremely excellent antireflection characteristic) can be obtained.

The refractive index characteristic of the retardation layer preferably shows a relationship of nx>ny≧nz. In one embodiment, the retardation layer can function as a λ/4 plate. In this case, the retardation layer has an in-plane retardation Re(550) of preferably from 80 nm to 200 nm, more preferably from 100 nm to 180 nm, still more preferably from 110 nm to 170 nm. The expression “ny=nz” as used herein includes not only the case where the ny and the nz are completely equal to each other but also the case where the ny and the nz are substantially equal to each other. Therefore, the ny may be smaller than the nz to the extent that the effects of the present invention are not impaired.

The birefringent index Δn_{xy} of the retardation layer is preferably 0.0025 or more, more preferably 0.0028 or more. Meanwhile, an upper limit for the birefringent index Δn_{xy} is, for example, 0.0060, preferably 0.0050. When the birefringent index is optimized to such range, a retardation layer that is thin and has desired optical characteristics can be obtained.

The Nz coefficient of the retardation layer is preferably from 0.9 to 3, more preferably from 0.9 to 2.5, still more preferably from 0.9 to 1.5, particularly preferably from 0.9 to 1.3. When such relationship is satisfied, in the case of using the optical laminate to be obtained for an image display apparatus, an extremely excellent reflection hue can be achieved.

The retardation layer may show a reverse wavelength dispersion characteristic, i.e., a retardation value increasing with an increase in wavelength of measurement light, may show a positive wavelength dispersion characteristic, i.e., a retardation value decreasing with an increase in wavelength of measurement light, or may show a flat wavelength dispersion characteristic, i.e., a retardation value hardly changing even when the wavelength of measurement light changes. The retardation layer preferably shows the reverse wavelength dispersion characteristic. In this case, the ratio Re(450)/Re(550) of the retardation layer is preferably 0.8 or more and less than 1, more preferably 0.8 or more and 0.95 or less. With such construction, an extremely excellent antireflection characteristic can be achieved, and specifically, a neutral black reflection color can be achieved with the retardation layer alone. In the present invention, even when a retardation layer showing a reverse wavelength dispersion characteristic is formed, a change in retardation of the retardation layer is small and color unevenness that occurs with time is prevented.

The retardation layer contains a resin having a photoelastic coefficient of preferably 30×10⁻¹² Pa or less, more preferably from 10×10⁻¹² Pa to 20×10⁻¹² Pa, still more preferably from 1×10⁻¹² Pa to 10×10⁻¹² Pa. When the photoelastic coefficient falls within such range, a retardation layer in which a retardation change is less liable to be generated in the case where a shrinkage stress is generated at the time of heating can be formed.

The thickness of the retardation layer is preferably 50 μm or less, more preferably from 20 μm to 50 μm.

The retardation layer may include any appropriate resin film. Typical examples of the resin constituting the resin film include a cyclic olefin-based resin, a polycarbonate-based resin, a cellulose-based resin, a polyester-based resin, a polyvinyl alcohol-based resin, a polyamide-based resin, a polyimide-based resin, a polyether-based resin, a polystyrene-based resin, and an acrylic resin. Of those, a polycarbonate-based resin is preferred.

Any appropriate polycarbonate-based resin is used as the polycarbonate-based resin. In one embodiment, a polycarbonate-based resin containing a structural unit derived from a dihydroxy compound may be used. The dihydroxy compound is, for example, a dihydroxy compound represented by the following general formula (1).

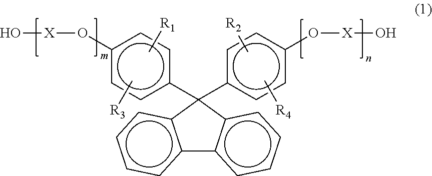

(In the general formula (1), R₁ to R₄ each independently represent a hydrogen atom, a substituted or unsubstituted alkyl group having 1 to 20 carbon atoms, a substituted or unsubstituted cycloalkyl group having 6 to 20 carbon atoms, or a substituted or unsubstituted aryl group having 6 to 20 carbon atoms, X represents a substituted or unsubstituted alkylene group having 2 to 10 carbon atoms, a substituted or unsubstituted cycloalkylene group having 6 to 20 carbon atoms, or a substituted or unsubstituted arylene group having 6 to 20 carbon atoms, and m and n each independently represent an integer of from 0 to 5.)

Specific examples of the dihydroxy compound represented by the general formula (1) include 9,9-bis(4-hydroxyphenyl) fluorene,
9,9-bis(4-hydroxy-3-methylphenyl)fluorene,
9,9-bis(4-hydroxy-3-ethylphenyl)fluorene,
9,9-bis(4-hydroxy-3-n-propylphenyl)fluorene,
9,9-bis(4-hydroxy-3-isopropylphenyl)fluorene,
9,9-bis(4-hydroxy-3-n-butylphenyl)fluorene,
9,9-bis(4-hydroxy-3-sec-butylphenyl)fluorene,
9,9-bis(4-hydroxy-3-tert-butylphenyl)fluorene,
9,9-bis(4-hydroxy-3-cyclohexylphenyl)fluorene,
9,9-bis(4-hydroxy-3-phenylphenyl)fluorene,
9,9-bis(4-(2-hydroxyethoxy)phenyl)fluorene,
9,9-bis(4-(2-hydroxyethoxy)-3-methylphenyl)fluorene,
9,9-bis(4-(2-hydroxyethoxy)-3-isopropylphenyl)fluorene,
9,9-bis(4-(2-hydroxyethoxy)-3-isobutylphenyl)fluorene,
9,9-bis(4-(2-hydroxyethoxy)-3-tert-butylphenyl)fluorene,
9,9-bis(4-(2-hydroxyethoxy)-3-cyclohexylphenyl)fluorene,
9,9-bis(4-(2-hydroxyethoxy)-3-phenylphenyl)fluorene,
9,9-bis(4-(2-hydroxyethoxy)-3,5-dimethylphenyl) fluorene,
9,9-bis(4-(2-hydroxyethoxy)-3-tert-butyl-6-methylphenyl)fluorene, and
9,9-bis(4-(3-hydroxy-2,2-dimethylpropoxy)phenyl)fluorene.

The polycarbonate-based resin may contain a structural unit derived from the dihydroxy compound and a structural unit derived from a dihydroxy compound, such as isosorbide, isomannide, isoidide, spiroglycol, dioxane glycol, diethylene glycol (DEG), triethylene glycol (TEG), polyethylene glycol (PEG), or a bisphenol.

The polycarbonate-based resin containing a structural unit derived from the dihydroxy compound is disclosed in, for example, Japanese Patent No. 5204200, Japanese Patent Application Laid-open No. 2012-67300, Japanese Patent No. 3325560, and International Patent WO2014/061677A in detail. The disclosures of the patent literatures are incorporated herein by reference.

In one embodiment, a polycarbonate-based resin containing an oligofluorene structural unit can be used. The polycarbonate-based resin containing an oligofluorene structural unit is, for example, a resin containing a structural unit represented by the following general formula (2) and/or a structural unit represented by the following general formula (3).

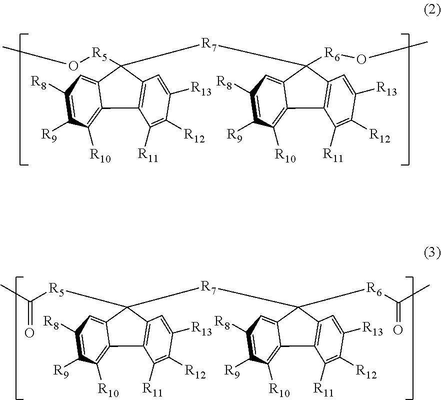

(In the general formula (2) and the general formula (3), R₅ and R₆ each independently represent a direct bond, or a substituted or unsubstituted alkylene group having 1 to 4 carbon atoms (preferably an alkylene group having 2 to 3 carbon atoms on its main chain), R₇ represents a direct bond, or a substituted or unsubstituted alkylene group having 1 to 4 carbon atoms (preferably an alkylene group having 1 to 2 carbon atoms on its main chain), R₈ to R₁₃ each independently represent a hydrogen atom, a substituted or unsubstituted alkyl group having 1 to 10 (preferably 1 to 4, more preferably 1 to 2) carbon atoms, a substituted or unsubstituted aryl group having 4 to 10 (preferably 4 to 8, more preferably 4 to 7) carbon atoms, a substituted or unsubstituted acyl group having 1 to 10 (preferably 1 to 4, more preferably 1 to 2) carbon atoms, a substituted or unsubstituted alkoxy group having 1 to 10 (preferably 1 to 4, more preferably 1 to 2) carbon atoms, a substituted or unsubstituted aryloxy group having 1 to 10 (preferably 1 to 4, more preferably 1 to 2) carbon atoms, a substituted or unsubstituted acyloxy group having 1 to 10 (preferably 1 to 4, more preferably 1 to 2) carbon atoms, a substituted or unsubstituted amino group, a substituted or unsubstituted vinyl group having 1 to 10 (preferably 1 to 4) carbon atoms, a substituted or unsubstituted ethynyl group having 1 to 10 (preferably 1 to 4) carbon atoms, a sulfur atom having a substituent, a silicon atom having a substituent, a halogen atom, a nitro group, or a cyano group, and at least two adjacent groups out of R₈ to R₁₃ may be bonded to each other to form a ring.)

In one embodiment, a fluorene ring in an oligofluorene structural unit has a construction in which all of R₈ to R₁₃ represent hydrogen atoms, or has a construction in which R₈ and/or R₁₃ each represent/represents an atom or a group selected from the group consisting of a halogen atom, an acyl group, a nitro group, a cyano group, and a sulfo group, and R₉ to R₁₂ represent hydrogen atoms.

The polycarbonate-based resin containing an oligofluorene structural unit is disclosed in, for example, Japanese Patent Application Laid-open No. 2015-212816 in detail. The disclosure of the patent literature is incorporated herein by reference.

The glass transition temperature of the polycarbonate-based resin is preferably from 110° C. to 150° C., more preferably from 120° C. to 140° C. When the glass transition temperature is excessively low, the heat resistance of the resin tends to deteriorate and hence the resin may cause a dimensional change after its forming into a film. When the glass transition temperature is excessively high, the forming stability of the resin at the time of its forming into a film may deteriorate. In addition, the transparency of the film may be impaired. The glass transition temperature is determined in conformity with JIS K 7121 (1987).

The resin film may be obtained by any appropriate method. For example, the resin film can be obtained by stretching an unstretched resin film.

Any appropriate stretching method and stretching conditions (such as a stretching temperature, a stretching ratio, and a stretching direction) may be adopted for the stretching. Specifically, one kind of various stretching methods, such as free-end stretching, fixed-end stretching, free-end shrinkage, and fixed-end shrinkage, can be employed alone, or two or more kinds thereof can be employed simultaneously or sequentially. With regard to the stretching direction, the stretching can be performed in various directions or dimensions, such as a lengthwise direction, a widthwise direction, a thickness direction, and an oblique direction. When the glass transition temperature of the resin film is represented by Tg, the stretching temperature falls within a range of preferably from Tg−30° C. to Tg+60° C., more preferably from Tg−10° C. to Tg+50° C.

A resin film having the desired optical characteristics (such as a refractive index characteristic, an in-plane retardation, and an Nz coefficient) can be obtained by appropriately selecting the stretching method and stretching conditions.

In one embodiment, the resin film is produced by subjecting an unstretched resin film to uniaxial stretching or fixed-end uniaxial stretching. The fixed-end uniaxial stretching is specifically, for example, a method involving stretching the resin film in its widthwise direction (lateral direction) while running the film in its lengthwise direction. The stretching ratio is preferably from 1.1 times to 3.5 times.

In another embodiment, the retardation film may be produced by continuously subjecting a resin film having an elongate shape to oblique stretching in the direction of the angle θ with respect to a lengthwise direction. When the oblique stretching is adopted, a stretched film having an elongate shape and having an alignment angle which is the angle θ with respect to the lengthwise direction of the film (having a slow axis in the direction of the angle θ) is obtained, and for example, roll-to-roll manufacture can be performed in its lamination with the polarizer, with the result that the manufacturing process can be simplified. The angle θ may be an angle formed between the absorption axis of the polarizer and the slow axis of the retardation layer in the antireflection film. As described above, the angle θ is preferably from 38° to 52°, more preferably from 42° to 48°, still more preferably about 45°.

As a stretching machine to be used for the oblique stretching, for example, there is given a tenter stretching machine capable of applying feeding forces, or tensile forces or take-up forces, having different speeds on left and right sides in a lateral direction and/or a longitudinal direction. Examples of the tenter stretching machine include a lateral uniaxial stretching machine and a simultaneous biaxial stretching machine, and any appropriate stretching machine may be used as long as the resin film having an elongate shape can be continuously subjected to the oblique stretching.

Through appropriate control of each of the speeds on the left and right sides in the stretching machine, a retardation layer (substantially a retardation film having an elongate shape) having the desired in-plane retardation and having a slow axis in the desired direction can be obtained.

The stretching temperature of the film may be changed depending on, for example, the desired in-plane retardation value and thickness of the retardation layer, the kind of the resin to be used, the thickness of the film to be used, and a stretching ratio.

Specifically, the stretching temperature is preferably from Tg−30° C. to Tg+30° C., more preferably from Tg−15° C. to Tg+15° C., most preferably from Tg−10° C. to Tg+10° C. When the stretching is performed at such temperature, a retardation layer having characteristics which are appropriate in the present invention can be obtained. Tg refers to the glass transition temperature of the material constituting the film.

(Protective Film)

The protective film is formed of any appropriate resin. The resin for forming the protective film is specifically, for example: a cellulose-based resin, such as triacetylcellulose (TAC); a transparent resin, such as a polyester-based, polyvinyl alcohol-based, polycarbonate-based, polyamide-based, polyimide-based, polyether sulfone-based, polysulfone-based, polystyrene-based, polynorbornene-based, polyolefin-based, (meth)acrylic, or acetate-based transparent resin; or a thermosetting resin or a UV-curable resin, such as a (meth)acrylic, urethane-based, (meth)acrylic urethane-based, epoxy-based, or silicone-based thermosetting resin or UV-curable resin. In addition, examples thereof also include a glassy polymer, such as a siloxane-based polymer. In addition, a polymer film disclosed in Japanese Patent Application Laid-open No. 2001-343529 (International Patent WO01/37007A) may also be used. For example, a resin composition containing a thermoplastic resin having a substituted or unsubstituted imide group on a side chain thereof, and a thermoplastic resin having a substituted or unsubstituted phenyl group and a nitrile group on side chains thereof can be used as the material for the film, and the composition is, for example, a resin composition having an alternating copolymer formed of isobutene and N-methylmaleimide, and an acrylonitrile-styrene copolymer. The polymer film can be, for example, an extrudate of the resin composition.

Any appropriate thickness may be adopted as the thickness of the protective film as long as the effects of the present invention are obtained. The thickness of the protective film is, for example, from 20 μm to 40 μm, preferably from 25 μm to 35 μm.

(Adhesive Layer)

The polarizer, and the retardation layer and the protective film can be laminated through intermediation of the adhesive layer. Any appropriate adhesive is used as an adhesive constituting the adhesive layer. For example, the adhesive layer is formed of a polyvinyl alcohol-based adhesive.

The thickness of the adhesive layer is preferably 1 μm or less, more preferably 0.8 μm or less. When the thickness falls within such range, an optical laminate in which a change in retardation of its retardation layer is small and color unevenness that occurs with time is prevented can be obtained. A lower limit for the thickness of the adhesive layer is, for example, 0.01 μm.

(Pressure-Sensitive Adhesive Layer)

As described above, the antireflection film includes the pressure-sensitive adhesive layer, and can be bonded to the first substrate through intermediation of the pressure-sensitive adhesive layer. Any appropriate pressure-sensitive adhesive is used as a pressure-sensitive adhesive constituting the pressure-sensitive adhesive layer. For example, the pressure-sensitive adhesive layer is formed of an acrylic pressure-sensitive adhesive.

The thickness of the pressure-sensitive adhesive layer is preferably from 5 μm to 30 μm, more preferably from 5 μm to 15 μm. In the present invention, when the resin layer is formed, the expansion and shrinkage of the antireflection film are suppressed, and hence the foaming and peeling of the pressure-sensitive adhesive layer can be prevented. Accordingly, the thickness of the pressure-sensitive adhesive layer can be reduced, and hence a thin optical laminate can be obtained.

(Other Layer)

The antireflection film may further include any other layer. The other layer is, for example, a retardation layer different from the above-mentioned retardation layer. In one embodiment, the antireflection film can further include a retardation layer (a retardation film or a liquid crystal layer) that has a refractive index distribution of nz>nx=ny and can function as a positive C-plate. The expression “nx=ny” as used herein includes not only the case where the nx and the ny are strictly equal to each other but also the case where the nx and the ny are substantially equal to each other. That is, the expression means that the Re of the film is less than 10 nm. The thickness direction retardation Rth of the retardation layer that can function as a positive C-plate is preferably from −20 nm to −200 nm, more preferably from −40 nm to −180 nm, particularly preferably from −40 nm to −160 nm. The thickness of the retardation layer with which such Rth can be obtained may vary depending on a material to be used or the like. The thickness is preferably from 0.5 μm to 60 μm, more preferably from 0.5 μm to 50 μm, most preferably from 0.5 μm to 40 μm.

C. Resin Layer

The resin layer is arranged between the first substrate and the second substrate so as to cover the antireflection film. Such resin layer can be formed by, for example, laminating the antireflection film on the first substrate, then applying a curable composition for forming a resin layer so that the antireflection film may be sealed, and then curing the composition for forming a resin layer. In addition, the resin layer may be formed by: applying the composition for forming a resin layer onto another base material; then bringing the composition for forming a resin layer into a semi-cured state to form a precursor layer; transferring the precursor layer onto a laminate of the first substrate and the antireflection film; and then curing the precursor layer.

The composition for forming a resin layer contains a curable compound (monomer or oligomer). Examples of the curable compound include an acrylic compound, an epoxy-based compound, and a urethane-based compound.

The acrylic compound preferably has a hydroxyl group, a carboxyl group, a cyano group, an amino group, an amide group, a heterocyclic group, a lactone ring group, and/or an isocyanate ring group. The use of a composition for forming a resin layer containing an acrylic compound having any such functional group enables the formation of a resin layer excellent in adhesion with each of the first substrate and the second substrate.

Specific examples of the acrylic compound include: an acrylic compound having a hydroxy group, such as 2-hydroxyethyl (meth)acrylate, 2-hydroxypropyl (meth)acrylate, or 4-hydroxybutyl (meth)acrylate; an acrylic compound having a carboxyl group, such as acrylic acid or methacrylic acid; an acrylic compound having a cyano group, such as acrylonitrile or methacrylonitrile; an acrylic compound having an amino group, such as dimethylaminoethyl (meth)acrylate, dimethylaminopropyl (meth)acrylate, diethylaminoethyl (meth)acrylate, or diisopropylaminoethyl (meth)acrylate; an acrylic compound having an amide group, such as acrylamide, dimethylacrylamide, dimethylaminopropylacrylamide, isopropylacrylamide, diethylacrylamide, hydroxyethylacrylamide, or acryloylmorpholine; an acrylic compound having a heterocycle, such as tetrahydrofurfuryl (meth)acrylate, glycidyl (meth)acrylate, pentamethylpiperidinyl (meth)acrylate, or tetramethylpiperidinyl (meth)acrylate; an acrylic compound having a lactone ring, such as γ-butyrolactone (meth)acrylate monomer; and an acrylic compound having an isocyanate group, such as 2-isocyanatoethyl (meth)acrylate monomer. The acrylic compounds may be used alone or in combination.

The composition for forming a resin layer may contain, as the acrylic compound, a polyfunctional acrylic monomer (that is, an acrylic monomer having a plurality of acryloxy groups), an oligomer derived from a polyfunctional acrylic monomer, and/or a prepolymer derived from a polyfunctional acrylic monomer. Examples of the polyfunctional acrylic monomer include tricyclodecanedimethanol diacrylate, pentaerythritol di(meth)acrylate, pentaerythritol tri(meth)acrylate, trimethylolpropane triacrylate, pentaerythritol tetra(meth)acrylate, dimethylolpropane tetraacrylate, dipentaerythritol hexa(meth)acrylate, 1,6-hexanediol (meth)acrylate, 1,9-nonanediol diacrylate, 1,10-decanediol (meth)acrylate, polyethylene glycol di(meth)acrylate, polypropylene glycol di(meth)acrylate, dipropylene glycol diacrylate, isocyanuric acid tri(meth)acrylate, ethoxylated glycerin triacrylate, and ethoxylated pentaerythritol tetraacrylate. The polyfunctional acrylic monomers may be used alone or in combination.

The content of the polyfunctional acrylic monomer in the composition for forming a resin layer is preferably 5 parts by weight or less, more preferably 1 part by weight or less with respect to 100 parts by weight of the curable compound in the composition for forming a resin layer. In one embodiment, a composition for forming a resin layer free of any polyfunctional acrylic monomer is used. The use of such resin composition can suppress shrinkage due to a curing process, and as a result, enables the formation of a resin layer excellent in adhesiveness with each of the substrates.

Examples of the epoxy-based compound include epoxy-based compounds of the following types: a bisphenol type, such as a bisphenol A type, a bisphenol F type, or a bisphenol S type, or a hydrogenated product thereof; a novolac type, such as a phenol novolac type or a cresol novolac type; a nitrogen-containing ring type, such as a triglycidyl isocyanurate type or a hydantoin type; an alicyclic type; an aliphatic type; a naphthalene type; a low water absorption type, such as a glycidyl ether type or a biphenyl type; a dicyclo type, such as a dicyclopentadiene type; an ester type; an ether ester type; and modified types thereof. Examples of the bisphenol-type epoxy compound include diglycidyl ether of bisphenol A, diglycidyl ether of bisphenol F, and diglycidyl ether of bisphenol S. Examples of the alicyclic epoxy compound include 3,4-epoxycyclohexylmethyl 3,4-epoxycyclohexanecarboxylate and 3,4-epoxy-6-methylcyclohexylmethyl 3,4-epoxy-6-methylcyclohexanecarboxylate. Examples of the aliphatic epoxy compound include diglycidyl ether of 1, 4-butanediol, diglycidyl ether of 1, 6-hexanediol, triglycidyl ether of glycerin, and triglycidyl ether of trimethylolpropane.

In one embodiment, the epoxy-based compound and an oxetane-based compound are used in combination. The addition of the oxetane-based compound can reduce the viscosity of the composition for forming a resin layer or increase its curing rate.

The composition for forming a resin layer may contain, as the urethane-based compound, a urethane (meth)acrylate and/or an oligomer of the urethane (meth)acrylate. The urethane (meth)acrylate can be obtained by, for example, subjecting a hydroxy(meth)acrylate obtained from (meth)acrylic acid or a (meth)acrylate and a polyol to a reaction with a diisocyanate. The urethane (meth)acrylates and oligomers of the urethane (meth)acrylates may be used alone or in combination.

Examples of the (meth)acrylate include methyl (meth)acrylate, ethyl (meth)acrylate, isopropyl (meth)acrylate, butyl (meth)acrylate, and cyclohexyl (meth)acrylate.

Examples of the polyol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, neopentyl glycol hydroxypivalate, tricyclodecanedimethylol, 1,4-cyclohexanediol, spiroglycol, hydrogenated bisphenol A, a bisphenol A-ethylene oxide adduct, a bisphenol A-propylene oxide adduct, trimethylolethane, trimethylolpropane, glycerin, 3-methylpentane-1,3,5-triol, pentaerythritol, dipentaerythritol, tripentaerythritol, and glucoses.

For example, various kinds of aromatic, aliphatic, and alicyclic diisocyanates can be used as the diisocyanate. Specific examples of the diisocyanate include tetramethylene diisocyanate, hexamethylene diisocyanate, isophorone diisocyanate, 2, 4-tolylene diisocyanate, 4,4-diphenyl diisocyanate, 1,5-naphthalene diisocyanate, 3,3-dimethyl-4,4-diphenyl diisocyanate, xylene diisocyanate, trimethylhexamethylene diisocyanate, 4,4-diphenylmethane diisocyanate, and hydrogenated products thereof.

The composition for forming a resin layer may or may not contain a solvent. Examples of the solvent include dibutyl ether, dimethoxymethane, methyl acetate, ethyl acetate, isobutyl acetate, methyl propionate, ethyl propionate, methanol, ethanol, and methyl isobutyl ketone (MIBK). Those solvents may be used alone or in combination.

The composition for forming a resin layer can further contain any appropriate additive. Examples of the additive include a polymerization initiator, a cross-linking agent, a leveling agent, an antiblocking agent, a dispersion stabilizer, a thixotropic agent, an antioxidant, a UV absorber, an antifoaming agent, a thickener, a dispersant, a surfactant, a catalyst, a filler, a lubricant, and an antistatic agent.

In one embodiment, the composition for forming a resin layer contains a coupling agent. A resin layer containing the coupling agent is preferred because the layer is excellent in adhesiveness with each of the first substrate, the second substrate, and the antireflection film. Examples of the coupling agent include an epoxy-terminated coupling agent, an amino group-containing coupling agent, a methacryl group-containing coupling agent, and a thiol group-containing coupling agent.

As a method of applying the composition for forming a resin layer, any appropriate method may be adopted. Examples of the method include a bar coating method, a roll coating method, a gravure coating method, a rod coating method, a slot orifice coating method, a curtain coating method, a fountain coating method, and a comma coating method.

Any appropriate curing treatment may be adopted as a method of curing the composition for forming a resin layer. The curing treatment is typically performed by UV irradiation. The integrated light quantity of the UV irradiation is preferably from 500 mJ/cm² to 5,000 mJ/cm². In addition, the composition for forming a resin layer may be cured by heating. A heating temperature at the time of the thermal curing is, for example, from 90° C. to 150° C.

The thickness of the thinnest portion of the resin layer (i.e., a distance between the second substrate and the antireflection film) is preferably from 1 μm to 300 μm, more preferably from 1 μm to 100 μm, still more preferably from 1 μm to 30 μm. When the thickness falls within such range, the dimensional change of the retardation layer can be effectively suppressed.

The storage modulus of elasticity E′ of the resin layer at 25° C. is preferably 1.0×10⁶ Pa or more, more preferably 1.0×10⁷ Pa or more, still more preferably 1.0×10⁸ Pa or more, particularly preferably from 1.0×10⁹ Pa to 1.0×10¹¹ Pa. When the storage modulus of elasticity falls within such range, the dimensional change of the retardation layer can be effectively suppressed. A method of measuring the storage modulus of elasticity E′ is described later.

The glass transition temperature (Tg) of the resin layer is preferably from 10° C. to 200° C., more preferably from 20° C. to 150° C., still more preferably from 40° C. to 130° C.

D. First Substrate, Second Substrate

The first substrate may include any appropriate material. Examples of the material constituting the first substrate include a glass and a resin film. In one embodiment, the first substrate can be a substrate constituting the outermost layer of an image display panel (e.g., an organic EL panel). In this case, the anti reflection film constituting the optical laminate of the present invention is arranged on the viewer side surface of the image display panel.

The second substrate may include any appropriate material. Examples of the material constituting the second substrate include a glass and a resin film.

The optical laminate of the present invention can be formed by: laminating the antireflection film on the first substrate; and then bonding the laminate including the first substrate and the antireflection film, and the second substrate to each other through intermediation of the resin layer so that the antireflection film may be sandwiched between the substrates. A method of forming the resin layer is as described in the section C.

### EXAMPLES

Now, the present invention is specifically described by way of Examples. However, the present invention is not limited by these Examples.

### Production Example 1-1

### Production of Retardation Film a Constituting Retardation Layer

### (Production of Polycarbonate Resin Film)

Polymerization was performed with a batch polymerization apparatus formed of two vertical reactors each including a stirring blade and a reflux condenser controlled to 100° C. 9,9-[4-(2-Hydroxyethoxy)phenyl]fluorene (BHEPF), isosorbide (ISB), diethylene glycol (DEG), diphenyl carbonate (DPC), and magnesium acetate tetrahydrate were loaded into the first reactor so that a molar ratio “BHEPF/ISB/DEG/DPC/magnesium acetate” became 0.348/0.490/0.162/1.005/1.00×10⁻⁵. After the reactor had been sufficiently purged with nitrogen (oxygen concentration: 0.0005 vol % to 0.001 vol %), warming was performed with a heat medium and stirring was initiated at the time point when a temperature in the reactor became 100° C. The temperature in the reactor was caused to reach 220° C. 40 minutes after the initiation of the temperature increase, and the reactor was controlled to hold the temperature. Simultaneously with the control, a pressure reduction was initiated to reduce a pressure in the reactor to 13.3 kPa 90 minutes after the temperature had reached 220° C. A phenol vapor produced as a by-product in association with a polymerization reaction was introduced into the reflux condenser at 100° C., a monomer component present in a certain amount in the phenol vapor was returned to the reactor, and the phenol vapor that was not condensed was introduced into a condenser at 45° C. and recovered.

Nitrogen was introduced into the first reactor to return the pressure to atmospheric pressure once. After that, an oligomerized reaction liquid in the first reactor was transferred to the second reactor. Next, an increase in temperature in the second reactor and a reduction in pressure therein were initiated to set the temperature and the pressure therein to 240° C. and 0.2 kPa, respectively over 50 minutes. After that, the polymerization was advanced until predetermined stirring power was reached. At the time point when the predetermined power was reached, nitrogen was introduced into the reactor to return the pressure to atmospheric pressure, and the reaction liquid was extracted in the form of a strand, followed by its pelletization with a rotary cutter. Thus, a polycarbonate resin having a copolymer composition “BHEPF/ISB/DEG” of 34.8/49.0/16.2 [mol %] was obtained. The polycarbonate resin had a reduced viscosity of 0.430 dL/g and a glass transition temperature of 128° C.

The resultant polycarbonate resin was vacuum-dried at 80° C. for 5 hours, and then a polycarbonate resin film having a thickness of 140 μm was produced using a film-forming apparatus with a single-screw extruder (manufactured by Isuzu Kakoki, screw diameter: 25 mm, cylinder preset temperature: 220° C.), a T-die (width: 900 mm, preset temperature: 220° C.), a chill roll (preset temperature: 120° C. to 130° C.), and a take-up unit.

### (Production of Retardation Film)

The unstretched modified polycarbonate film was obliquely stretched to provide a retardation film A (thickness: 50 μm, photoelastic coefficient: 30×10⁻¹² Pa, wavelength dispersion characteristic Re(450)/Re(550): 0.91). At that time, a stretching direction was set to 45° relative to the lengthwise direction of the film. In addition, a stretching ratio was adjusted to from 2 times to 3 times so that the retardation film A expressed a retardation of λ/4. In addition, a stretching temperature was set to 133° C. (i.e., the Tg of the unstretched modified polycarbonate film plus 5° C.).

### Production Example 1-2

### Production of Retardation Film B Constituting Retardation Layer

### (Production of Polycarbonate Resin Film)

38.06 Parts by weight (0.059 mol) of bis[9-(2-phenoxycarbonylethyl)fluoren-9-yl]methane, 53.73 parts by weight (0.368 mol) of isosorbide (manufacturedby Roquette Freres, trade name: “POLYSORB”), 9.64 parts by weight (0.067 mol) of 1,4-cyclohexanedimethanol (cis-trans mixture, manufactured by SK Chemicals), 81.28 parts by weight (0.379 mol) of diphenyl carbonate (manufactured by Mitsubishi Chemical Corporation), and 3.83×10⁻⁴ part by weight (2.17×10⁻⁶ mol) of calcium acetate monohydrate serving as a catalyst were loaded into a reaction vessel, and the reaction apparatus was purged with nitrogen while a pressure therein was reduced. Under a nitrogen atmosphere, the raw materials were dissolved while being stirred at 150° C. for about 10 minutes. As the first step of a reaction, the temperature was increased to 220° C. over 30 minutes, and the solution was subjected to a reaction for 60 minutes at normal pressure. Next, the pressure was reduced from normal pressure to 13.3 kPa over 90 minutes, and the pressure was held at 13.3 kPa for 30 minutes, followed by the extraction of produced phenol to the outside of the reaction system. Next, as the second step of the reaction, while a heat medium temperature was increased to 240° C. over 15 minutes, the pressure was reduced to 0.10 kPa or less over 15 minutes, and produced phenol was extracted to the outside of the reaction system. After predetermined stirring torque had been reached, the reaction was stopped by returning the pressure to normal pressure with nitrogen. Produced polyester carbonate was extruded into water and the strand was cut to provide a polycarbonate resin pellet.

### (Production of Retardation Film)

A film including the polycarbonate resin pellet was obliquely stretched to provide a retardation film B (thickness: 50 μm, photoelastic coefficient: 16×10⁻¹² Pa, wavelength dispersion characteristic Re(450)/Re(550): 0.83). At that time, a stretching direction was set to 45° relative to the lengthwise direction of the film. In addition, a stretching ratio was adjusted to from 2 times to 3 times so that the retardation film B expressed a retardation of λ/4. In addition, a stretching temperature was set to 148° C. (i.e., the Tg of the unstretched modified polycarbonate film plus 5° C.).

### Production Example 2

### Production of Polarizer

A PVA-based resin film having a polymerization degree of 2,400, a saponification degree of 99.9 mol %, and a thickness of 30 μm was immersed in warm water at 30° C., and was uniaxially stretched so that the length of the PVA-based resin film became 2.0 times as long as its original length while the film was swollen. Next, the PVA-based resin film was immersed in an aqueous solution containing a mixture of iodine and potassium iodide (weight ratio: 0.5:8) at a concentration of 0.3 wt % (dyeing bath), and the film was dyed while being uniaxially stretched so that its length became 3.0 times as long as the original length. After that, the PVA-based resin film was stretched so that its length became 3.7 times as long as the original length while the film was immersed in an aqueous solution containing 5 wt % of boric acid and 3 wt % of potassium iodide (cross-linking bath 1). After that, the PVA-based resin film was stretched in an aqueous solution at 60° C. containing 4 wt % of boric acid and 5 wt % of potassium iodide (cross-linking bath 2) so that its length became 6 times as long as the original length. Further, the film was subjected to an iodine ion impregnation treatment in an aqueous solution containing 3 wt % of potassium iodide (iodine impregnation bath), and was then dried in an oven at 60° C. for 4 minutes to provide a polarizer.

### Production Example 3-1

### Production of Antireflection Film Using Retardation Film A

The retardation film A produced in Production Example 1-1 was laminated on one surface of the polarizer produced in Production Example 2 through intermediation of an adhesive layer including a polyvinyl alcohol-based adhesive, and a triacetylcellulose (TAC) film (manufactured by Konica Minolta, Inc., trade name: “KC2UA”, thickness: 25 μm) serving as a protective film was laminated on the other surface of the polarizer through intermediation of an adhesive layer including the polyvinyl alcohol-based adhesive. Thus, an antireflection film A-I (protective film/adhesive layer/polarizer/adhesive layer/retardation layer) was obtained. The polyvinyl alcohol-based adhesive was obtained by: dissolving a polyvinyl alcohol-based resin containing an acetoacetyl group (average polymerization degree: 1,200, saponification degree: 98.5 mol %, acetoacetylation degree: 5 mol %) in pure water under a temperature condition of 30° C.; and adjusting the solid content concentration of the solution to 4%.

### Production Example 3-2

### Production of Antireflection Film Using Retardation Film A

A triacetylcellulose (TAC) film (manufactured by Konica Minolta, Inc., trade name: “KC2UA”, thickness: 25 μm) serving as a protective film was laminated on each of both surfaces of the polarizer produced in Production Example 2 through intermediation of an adhesive layer including an aqueous adhesive. Thus, a polarizing plate was obtained. The retardation film A produced in Production Example 1-1 was laminated on one surface of the polarizing plate through intermediation of a pressure-sensitive adhesive layer including an acrylic pressure-sensitive adhesive. Thus, an antireflection film A-II (protective film/adhesive layer/polarizer/adhesive layer/protective film/pressure-sensitive adhesive layer/retardation layer) was obtained.

### Production Example 3-3

### Production of Antireflection Film Using Retardation Film B

The retardation film B produced in Production Example 1-2 was laminated on one surface of the polarizer produced in Production Example 2 through intermediation of an adhesive layer including a polyvinyl alcohol-based adhesive, and a triacetylcellulose (TAC) film (manufactured by Konica Minolta, Inc., trade name: “KC2UA”, thickness: 25 μm) serving as a protective film was laminated on the other surface of the polarizer through intermediation of an adhesive layer including the polyvinyl alcohol-based adhesive. Thus, an antireflection film B-I (protective film/adhesive layer/polarizer/adhesive layer/retardation layer) was obtained. The polyvinyl alcohol-based adhesive was obtained by: dissolving a polyvinyl alcohol-based resin containing an acetoacetyl group (average polymerization degree: 1,200, saponification degree: 98.5 mol %, acetoacetylation degree: 5 mol %) in pure water under a temperature condition of 30° C.; and adjusting the solid content concentration of the solution to 4%.

### Production Example 3-4

### Production of Antireflection Film Using Retardation Film B

A triacetylcellulose (TAC) film (manufactured by Konica Minolta, Inc., trade name: “KC2UA”, thickness: 25 μm) serving as a protective film was laminated on each of both surfaces of the polarizer produced in Production Example 2 through intermediation of an adhesive layer including an aqueous adhesive. Thus, a polarizing plate was obtained. The retardation film B produced in Production Example 1-2 was laminated on one surface of the polarizing plate through intermediation of a pressure-sensitive adhesive layer including an acrylic pressure-sensitive adhesive. Thus, an antireflection film B-II (protective film/adhesive layer/polarizer/adhesive layer/protective film/pressure-sensitive adhesive layer/retardation layer) was obtained.

### Production Example 4-1

### Preparation of Composition for Forming Resin Layer

A composition 1 for forming a resin layer was prepared by mixing 100 parts by weight of 2-hydroxyethyl acrylamide (manufactured by Kohjin Co., Ltd.; hereinafter sometimes referred to as “HEAA”) and 1 part by weight of a photopolymerization initiator (manufactured by BASF, trade name: “Irgacure 819”).

### Production Example 4-2

### Preparation of Composition for Forming Resin Layer

A composition 2 for forming a resin layer was prepared in the same manner as in Production Example 4-1 except that 70 parts by weight of HEAA and 30 parts by weight of 4-hydroxybutyl acrylate (manufactured by Osaka Organic Chemical Industry Ltd.; hereinafter sometimes referred to as “4-HBA”) were used instead of 100 parts by weight of HEAA.

### Production Example 4-3

### Preparation of Composition for Forming Resin Layer

A composition 3 for forming a resin layer was prepared in the same manner as in Production Example 4-1 except that 50 parts by weight of HEAA and 50 parts by weight of 4-HBA were used instead of 100 parts by weight of HEAA.

### Production Example 4-4

### Preparation of Composition for Forming Resin Layer

A composition 4 for forming a resin layer was prepared in the same manner as in Production Example 4-1 except that 30 parts by weight of HEAA and 70 parts by weight of 4-HBA were used instead of 100 parts by weight of HEAA.

### Production Example 4-5

### Preparation of Composition for Forming Resin Layer

A composition 5 for forming a resin layer was prepared in the same manner as in Production Example 4-1 except that 22 parts by weight of HEAA and 78 parts by weight of 4-HBA were used instead of 100 parts by weight of HEAA.

### Production Example 4-6

### Preparation of Composition for Forming Resin Layer

A composition 6 for forming a resin layer was prepared in the same manner as in Production Example 4-1 except that 15 parts by weight of HEAA and 85 parts by weight of 4-HBA were used instead of 100 parts by weight of HEAA.

### Production Example 4-7

### Preparation of Composition for Forming Resin Layer

A composition 7 for forming a resin layer was prepared in the same manner as in Production Example 4-1 except that 100 parts by weight of 4-HBA was used instead of 100 parts by weight of HEAA.

### Production Example 4-8

### Preparation of Composition for Forming Resin Layer

A resin composition 8 was prepared in the same manner as in Production Example 4-1 except that 70 parts by weight of 4-acryloylmorpholine (manufactured by Kohjin Co., Ltd.; hereinafter sometimes referred to as “ACMO”) and 30 parts by weight of tetrahydrofurfuryl acrylate (manufactured by Osaka Organic Chemical Industry Ltd., trade name: “Viscoat #150”; hereinafter sometimes referred to as “THFA”) were used instead of 100 parts by weight of HEAA.

### Production Example 4-9

### Preparation of Composition for Forming Resin Layer

A resin composition 9 was prepared in the same manner as in Production Example 4-1 except that 45 parts by weight of ACMO and 55 parts by weight of THFA were used instead of 100 parts by weight of HEAA.

### Production Example 4-10

### Preparation of Composition for Forming Resin Layer

A resin composition 10 was prepared in the same manner as in Production Example 4-1 except that 25 parts by weight of ACMO and 75 parts by weight of THFA were used instead of 100 parts by weight of HEAA.

### Production Example 5-1

### Preparation of Composition for Forming Resin Layer

A composition 11 for forming a resin layer was prepared by mixing 90 parts by weight of an epoxy compound (manufactured by Kyoeisha Chemical Co., Ltd., trade name: “EPOLIGHT 80MF”), 10 parts by weight of an oxetane compound (manufactured by Toagosei Co., Ltd., trade name: “OXT-221”), 3 parts by weight of a photopolymerization initiator (manufactured by San-Apro Ltd., trade name: “CPI-100P”), and 0.5 part by weight of a sensitizer (manufactured by Kawasaki Kasei Chemicals Ltd., trade name: “UVS-1331”).

### Production Example 5-2

### Preparation of Composition for Forming Resin Layer

A composition 12 for forming a resin layer was prepared in the same manner as in Production Example 5-1 except that 90 parts by weight of an epoxy compound (manufactured by Kyoeisha Chemical Co., Ltd., trade name: “EPOLIGHT 100MF”) was used instead of 90 parts by weight of the epoxy compound (manufactured by Kyoeisha Chemical Co., Ltd., trade name: “EPOLIGHT 80MF”).

### Production Example 5-3

### Preparation of Composition for Forming Resin Layer

A composition 13 for forming a resin layer was prepared in the same manner as in Production Example 5-1 except that 90 parts by weight of an epoxy compound (manufactured by Kyoeisha Chemical Co., Ltd., trade name: “EPOLIGHT 40E”) was used instead of 90 parts by weight of the epoxy compound (manufactured by Kyoeisha Chemical Co., Ltd., trade name: “EPOLIGHT 80MF”).

### Example 1-1

An acrylic glass (manufactured by Matsunami Glass Ind., Ltd.) was used as a first substrate, and the anti reflection film A-I produced in Production Example 3-1 was laminated on the first substrate through intermediation of a pressure-sensitive adhesive layer including an acrylic pressure-sensitive adhesive. At this time, the lamination was performed so that the retardation layer of the antireflection film A-I was on the first substrate side.

Next, the composition 1 for forming a resin layer prepared in Production Example 4-1 was applied so as to cover the antireflection film A-I, and a second substrate (acrylic glass manufactured by Matsunami Glass Ind., Ltd.) was further laminated on the applied layer of the composition 1 for forming a resin layer. After that, the composition for forming a resin layer was cured by irradiating the formed laminate with UV light (dose: 5 J/cm²) through the use of a UV irradiator. Thus, an optical laminate having a construction illustrated in FIG. 1 was obtained.

### Examples 1-2 to 1-11, and Comparative Examples 1-1 and 1-2

Optical laminates were obtained in the same manner as in Example 1-1 except that compositions for forming resin layers shown in Table 1 were used instead of the composition 1 for forming a resin layer.

### Comparative Examples 1-3 to 1-15

Optical laminates were obtained in the same manner as in Example 1-1 except that: compositions for forming resin layers shown in Table 1 were used instead of the composition 1 for forming a resin layer; and the antireflection film A-II produced in Production Example 3-2 was used instead of the antireflection film A-I produced in Production Example 3-1.

### Comparative Example 1-16

An optical laminate was obtained in the same manner as in Example 1-1 except that: the composition 1 for forming a resin layer was not used; and the antireflection film and the second substrate were laminated with a spacer under a state in which a gap was present between the antireflection film and the second substrate.

### Example 2-1

An optical laminate was obtained in the same manner as in Example 1-1 except that the antireflection film B-I produced in Production Example 3-3 was used instead of the antireflection film A-I produced in Production Example 3-1.

### Examples 2-2 to 2-11, and Comparative Examples 2-1 and 2-2

Optical laminates were obtained in the same manner as in Example 2-1 except that compositions for forming resin layers shown in Table 2 were used instead of the composition 1 for forming a resin layer.

### Comparative Examples 2-3 to 2-15

Optical laminates were obtained in the same manner as in Example 2-1 except that: compositions for forming resin layers shown in Table 2 were used instead of the composition 1 for forming a resin layer; and the antireflection film B-II produced in Production Example 3-4 was used instead of the antireflection film B-I produced in Production Example 3-3.

### Comparative Example 2-16

An optical laminate was obtained in the same manner as in Example 2-1 except that: the composition 1 for forming a resin layer was not used; and the antireflection film and the second substrate were laminated with a spacer under a state in which a gap was present between the antireflection film and the second substrate.

<Evaluations>

The optical laminates obtained in Examples and Comparative Examples were subjected to the following evaluations. The results are shown in Table 1 and Table 2.

(1) Storage Modulus of Elasticity E′

A retardation layer (retardation film) sample measuring 5 mm wide by 30 mm long was prepared, and its storage moduli of elasticity E′ at from −40° C. to 120° C. were measured with “DMA RSA-III” manufactured by TA Instruments. Measurement conditions were as follows: a tensile mode, a rate of temperature increase of 10° C./min, a frequency of 1 Hz, and an initial strain of 0.1%.

(2) Glass Transition Temperature (Tg) of Resin Layer

A resin layer sample measuring 5 mm wide by 30 mm long was prepared, and its storage moduli of elasticity E′ and loss moduli of elasticity E″ at from −40° C. to 120° C. were measured with “DMA RSA-III” manufactured by TA Instruments, followed by the determination of its glass transition temperature Tg from the peak of tan δ=E″/E′. Measurement conditions were as follows: a tensile mode, a rate of temperature increase of 10° C./min, a frequency of 1 Hz, and an initial strain of 0.1%.

(3) External Appearance after Heating Test

Each of the resultant optical laminates was loaded into an oven at 85° C. for 240 hours, and a change in external appearance thereof was visually observed. A distance from the test sample to an eye of a measurer was set to any one of 5 cm, 30 cm, and 60 cm, and an evaluation was performed by the following criteria.

A: No color unevenness is observed when the distance from the test sample to the eye of the measurer is 5 cm.

B: No color unevenness is observed when the distance from the test sample to the eye of the measurer is 30 cm.

C: Color unevenness is slightly observed when the distance from the test sample to the eye of the measurer is 30 cm.

D: Color unevenness is observed when the distance from the test sample to the eye of the measurer is 60 cm.

E: Color unevenness is remarkably observed when the distance from the test sample to the eye of the measurer is 60 cm.

(4) Retardation Unevenness after Heating Test

Each of the resultant optical laminates was loaded into an oven at 85° C. for 240 hours. After the heating, the retardations of an end portion in the surface of the optical laminate and a central portion in the surface thereof were measured with “KOBRA-PR” manufactured by Oji Scientific Instruments, and its retardation unevenness was evaluated on the basis of a value determined from the equation “(retardation of end portion)−(retardation of central portion).”

(5) Dimensional Change after Heating Test

Each of the resultant optical laminates was loaded into an oven at 85° C. for 240 hours. The dimensions of its antireflection film before and after the heating were measured with a biaxial length-measuring machine manufactured by Mitutoyo Corporation, and a dimensional change caused by the heating (dimensional change in the stretching direction of its polarizer) was evaluated.

TABLE 1
Used retardation film: retardation film A (Production Example 1-1)

| | Bonding between | | | | | | | | |
|---|---|---|---|---|---|---|---|---|---|
| | polarizer (or | Resin layer | | | | | | | |
| | polarizing plate) and | | Storage | Storage | | | | | |
| | retardation layer | | modulus of | modulus of | Glass | External | Retardation | | |
| | Adhesive of | | elasticity E′ | elasticity E′ | transition | appearance | unevenness | | Dimensional |
| | pressure-sensitive | Composition for | at 25° C. | at 85° C. | temperature | after heating | after heating | | change after |
| | adhesive | forming resin layer | (×10⁶ Pa) | (×10⁶ Pa) | (° C.) | test | test | | heating test |
| Example 1-1 | Adhesive | Composition 1 for | 1,993.6 | 107.9 | 125 | A | ~3 | nm | <0.02% |
| | | forming resin layer | | | | | | | |
| Example 1-2 | | Composition 2 for | 603.5 | 0.5 | 80 | B | 3~6 | nm | <0.05% |
| | | forming resin layer | | | | | | | |
| Example 1-3 | | Composition 3 for | 60.2 | 0.2 | 52 | B | | | |
| | | forming resin layer | | | | | | | |
| Example 1-4 | | Composition 4 for | 13.3 | 0.2 | 24 | C | 6~10 | nm | <0.15% |
| | | forming resin layer | | | | | | | |
| Example 1-5 | | Composition 5 for | 2.3 | 0.2 | 15 | C | | | |
| | | forming resin layer | | | | | | | |
| Example 1-6 | | Composition 8 for | 1,278.9 | 904.1 | 103 | A | ~3 | nm | <0.02% |
| | | forming resin layer | | | | | | | |
| Example 1-7 | | Composition 9 for | 1,816.0 | 1.0 | 70 | A | | | |
| | | forming resin layer | | | | | | | |
| Example 1-8 | | Composition 10 for | 355.2 | 0.2 | 39 | B | 3~6 | nm | <0.05% |
| | | forming resin layer | | | | | | | |
| Example 1-9 | | Composition 11 for | 1,011.0 | 22.4 | 46 | A | ~3 | nm | <0.02% |
| | | forming resin layer | | | | | | | |
| Example 1-10 | | Composition 12 for | 600.3 | 24.8 | 57 | B | 3~6 | nm | <0.05% |
| | | forming resin layer | | | | | | | |
| Example 1-11 | | Composition 13 for | 18.1 | 16.4 | 2 | C | 6~10 | nm | <0.15% |
| | | forming resin layer | | | | | | | |
| Comparative | Adhesive | Composition 6 for | 0.9 | 0.2 | 2 | D | 12~16 | nm | 0.15% or more |
| Example 1-1 | | forming resin layer | | | | | | | |

| | | | | | | | | |
|---|---|---|---|---|---|---|---|---|
| Comparative | | Composition 7 for | 0.3 | 0.2 | −25 | D | | |
| Example 1-2 | | forming resin layer | | | | | | |
| Comparative | Pressure-sensitive | Composition 1 for | 1,993.6 | 107.9 | 125 | D | 16 nm or more | <0.02% |
| Example 1-3 | adhesive | forming resin layer | | | | | | |
| Comparative | | Composition 2 for | 603.5 | 0.5 | 80 | D | | <0.05% |
| Example 1-4 | | forming resin layer | | | | | | |
| Comparative | | Composition 3 for | 60.2 | 0.2 | 52 | D | | |
| Example 1-5 | | forming resin layer | | | | | | |
| Comparative | | Composition 4 for | 13.3 | 0.2 | 24 | D | | <0.15% |
| Example 1-6 | | forming resin layer | | | | | | |
| Comparative | | Composition 5 for | 2.3 | 0.2 | 15 | D | | |
| Example 1-7 | | forming resin layer | | | | | | |
| Comparative | | Composition 6 for | 0.9 | 0.2 | 2 | D | | 0.15% or more |
| Example 1-8 | | forming resin layer | | | | | | |
| Comparative | | Composition 7 for | 0.3 | 0.2 | −25 | D | | |
| Example 1-9 | | forming resin layer | | | | | | |
| Comparative | | Composition 8 for | 1,278.9 | 904.1 | 103 | D | | <0.02% |
| Example 1-10 | | forming resin layer | | | | | | |
| Comparative | | Composition 9 for | 1,816.0 | 1.0 | 70 | D | | <0.05% |
| Example 1-11 | | forming resin layer | | | | | | |
| Comparative | | Composition 10 for | 355.2 | 0.2 | 39 | D | | |
| Example 1-12 | | forming resin layer | | | | | | |
| Comparative | | Composition 11 for | 1,011.0 | 22.4 | 46 | D | | <0.02% |
| Example 1-13 | | forming resin layer | | | | | | |
| Comparative | | Composition 12 for | 600.3 | 24.8 | 57 | D | | <0.05% |
| Example 1-14 | | forming resin layer | | | | | | |
| Comparative | | Composition 13 for | 18.1 | 16.4 | 2 | D | | <0.15% |
| Example 1-15 | | forming resin layer | | | | | | |
| Comparative | | — | — | — | — | E | 18 nm or more | 0.50% or more |
| Example 1-16 | | | | | | | | |

TABLE 2
Used retardation film: retardation film B (Production Example 1-2)

| | Bonding between | | | | | | | | |
|---|---|---|---|---|---|---|---|---|---|
| | polarizer (or | Resin layer | | | | | | | |
| | polarizing plate) and | | Storage | Storage | | | | | |
| | retardation layer | | modulus of | modulus of | Glass | External | Retardation | | |
| | Adhesive of | | elasticity E′ | elasticity E′ | transition | appearance | unevenness | | Dimensional |
| | pressure-sensitive | Composition for | at 25° C. | at 85° C. | temperature | after heating | after heating | | change after |
| | adhesive | forming resin layer | (×10⁶ Pa) | (×10⁶ Pa) | (° C.) | test | test | | heating test |
| Example 2-1 | Adhesive | Composition 1 for | 1,993.6 | 107.9 | 125 | A | ~3 | nm | <0.02% |
| | | forming resin layer | | | | | | | |
| Example 2-2 | | Composition 2 for | 603.5 | 0.5 | 80 | B | 3~6 | nm | <0.05% |
| | | forming resin layer | | | | | | | |
| Example 2-3 | | Composition 3 for | 60.2 | 0.2 | 52 | B | | | |
| | | forming resin layer | | | | | | | |
| Example 2-4 | | Composition 4 for | 13.3 | 0.2 | 24 | ∘ | 6~9 | nm | <0.15% |
| | | forming resin layer | | | | | | | |
| Example 2-5 | | Composition 5 for | 2.3 | 0.2 | 15 | ∘ | | | |
| | | forming resin layer | | | | | | | |
| Example 2-6 | | Composition 8 for | 1,278.9 | 904.1 | 103 | A | ~3 | nm | <0.02% |
| | | forming resin layer | | | | | | | |
| Example 2-7 | | Composition 9 for | 1,816.0 | 1.0 | 70 | A | | | |
| | | forming resin layer | | | | | | | |
| Example 2-8 | | Composition 10 for | 355.2 | 0.2 | 39 | B | 3~6 | nm | <0.05% |
| | | forming resin layer | | | | | | | |
| Example 2-9 | | Composition 11 for | 1,011.0 | 22.4 | 46 | A | ~3 | nm | <0.02% |
| | | forming resin layer | | | | | | | |
| Example 2-10 | | Composition 12 for | 600.3 | 24.8 | 57 | B | 3~6 | nm | <0.05% |
| | | forming resin layer | | | | | | | |
| Example 2-11 | | Composition 13 for | 18.1 | 16.4 | 2 | C | 6~9 | nm | <0.15% |
| | | forming resin layer | | | | | | | |
| Comparative | Adhesive | Composition 6 for | 0.9 | 0.2 | 2 | D | 12~14 | nm | 0.15% or more |
| Example 2-1 | | forming resin layer | | | | | | | |

| | | | | | | | | |
|---|---|---|---|---|---|---|---|---|
| Comparative | | Composition 7 for | 0.3 | 0.2 | −25 | D | | |
| Example 2-2 | | forming resin layer | | | | | | |
| Comparative | Pressure-sensitive | Composition 1 for | 1,993.6 | 107.9 | 125 | D | 14 nm or more | <0.02% |
| Example 2-3 | adhesive | forming resin layer | | | | | | |
| Comparative | | Composition 2 for | 603.5 | 0.5 | 80 | D | | <0.05% |
| Example 2-4 | | forming resin layer | | | | | | |
| Comparative | | Composition 3 for | 60.2 | 0.2 | 52 | D | | |
| Example 2-5 | | forming resin layer | | | | | | |
| Comparative | | Composition 4 for | 13.3 | 0.2 | 24 | D | | <0.15% |
| Example 2-6 | | forming resin layer | | | | | | |
| Comparative | | Composition 5 for | 2.3 | 0.2 | 15 | D | | |
| Example 2-7 | | forming resin layer | | | | | | |
| Comparative | | Composition 6 for | 0.9 | 0.2 | 2 | D | | 0.15% or more |
| Example 2-8 | | forming resin layer | | | | | | |
| Comparative | | Composition 7 for | 0.3 | 0.2 | −25 | D | | |
| Example 2-9 | | forming resin layer | | | | | | |
| Comparative | | Composition 8 for | 1,278.9 | 904.1 | 103 | D | | <0.02% |
| Example 2-10 | | forming resin layer | | | | | | |
| Comparative | | Composition 9 for | 1,816.0 | 1.0 | 70 | D | | <0.05% |
| Example 2-11 | | forming resin layer | | | | | | |
| Comparative | | Composition 10 for | 355.2 | 0.2 | 39 | D | | |
| Example 2-12 | | forming resin layer | | | | | | |
| Comparative | | Composition 11 for | 1,011.0 | 22.4 | 46 | D | | <0.02% |
| Example 2-13 | | forming resin layer | | | | | | |
| Comparative | | Composition 12 for | 600.3 | 24.8 | 57 | D | | <0.05% |
| Example 2-14 | | forming resin layer | | | | | | |
| Comparative | | Composition 13 for | 18.1 | 16.4 | 2 | D | | <0.15% |
| Example 2-15 | | forming resin layer | | | | | | |
| Comparative | | — | — | — | — | E | 16 nm or more | 0.50% or more |
| Example 2-16 | | | | | | | | |

The optical laminate of the present invention is suitably used in an image display apparatus, such as a liquid crystal display apparatus or an organic EL display apparatus.

What is claimed is:

1. An optical laminate, comprising:
a first substrate;
a second substrate arranged on one side of the first substrate;
an antireflection film arranged between the first substrate and the second substrate; and
a resin layer arranged between the first substrate and the second substrate to cover the antireflection film,
wherein:
the antireflection film includes a polarizer and a retardation layer bonded to the polarizer; and
the resin layer has a storage modulus of elasticity at 25° C. of 1×10⁶ Pa or more.

2. The optical laminate according to claim 1, wherein the retardation layer functions as a λ/4 plate.

3. The optical laminate according to claim 1, wherein the retardation layer shows a reverse wavelength dispersion characteristic.

4. The optical laminate according to claim 1, wherein the retardation layer includes a polycarbonate-based resin film.

5. The optical laminate according to claim 1, wherein the retardation layer contains a resin having a photoelastic coefficient of 30×10⁻¹² Pa or less.

6. The optical laminate according to claim 1, wherein an angle formed between a slow axis of the retardation layer and an absorption axis of the polarizer is from 35° to 55°.

7. The optical laminate according to claim 1, wherein the polarizer and the retardation layer are laminated through intermediation of an adhesive layer, and the adhesive layer has a thickness of 1 μm or less.
